(19) United States
(12) Patent Application Publication
(10) Pub. No.: US 2018/0239396 A1
(43) Pub. Date: Aug. 23, 2018

(54) CONVERTER FOR MOBILE UNIT AND EXTERNAL KEYBOARD HAVING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: LI-CHIN LU, Tu-Cheng, New Taipei (TW); JIAN-HUA XIANG, Shenzhen (CN)

(21) Appl. No.: 15/473,853

(22) Filed: Mar. 30, 2017

(30) Foreign Application Priority Data
Feb. 17, 2017 (CN) 201710086309.0

(51) Int. Cl. G06F 1/16; G06F 3/023; G06F 3/02

(52) U.S. Cl. CPC G06F 1/1669; G06F 3/0233; G06F 1/1626; G06F 1/1632; G06F 3/0227

(57) ABSTRACT

A converter and an external keyboard having the converter are provided. The external keyboard can provide complete input to a mobile unit. The external keyboard further includes an input keyboard. The converter interconnects the input keyboard and a mobile phone. The converter comprises a plurality of first contact points. The input keyboard comprises a plurality of second contact points. Each first contact point abuts a second contact point. The converter transmit signals and translates to the mobile phone. When input keyboard is in operation, the converter converts at least one input signal from the input keyboard into the mobile phone.

### FIELD

The subject matter relates to a converter and an external keyboard having the converter.

### BACKGROUND

Current mobile phones generally use a virtual keyboard for language input. Due to the size restrictions of the screen of the mobile phone, the input keyboard of the mobile phone is very small, and it is inconvenient for the user to input.

### BRIEF DESCRIPTION OF THE DRAWINGS

Implementations of the present technology will now be described, by way of example only, with reference to the attached figures:

FIG. 1 is a schematic view of an external keyboard connected to a mobile phone in accordance with an exemplary embodiment of the present disclosure. The external keyboard includes a converter and an input keyboard.

FIG. 2 is an exploded view of the external keyboard and the mobile phone in FIG. 1.

FIG. 3 is an enlarged schematic view of the converter of FIG. 2.

FIG. 4 is a partially enlarged view of the converter as illustrated in the circled area IV in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

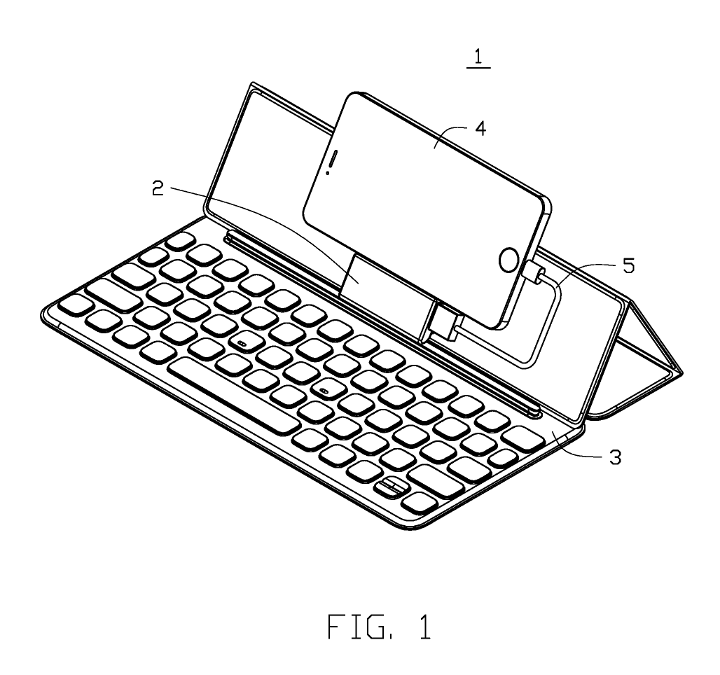

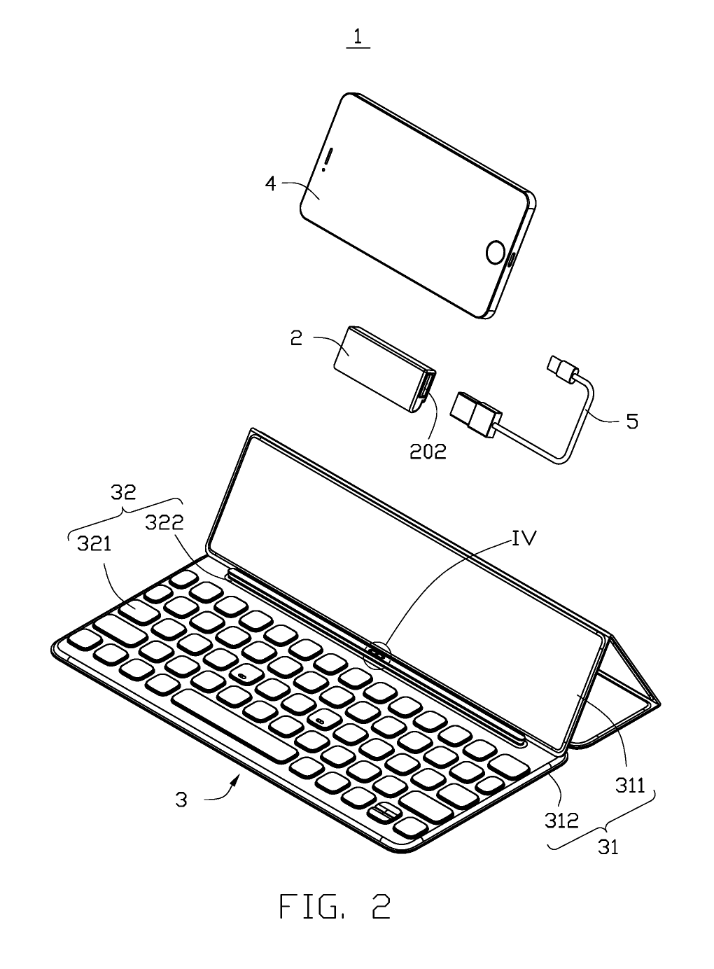

Referring to FIG. 1 to FIG. 4, the external keyboard 1 of an exemplary embodiment of the present disclosure includes a converter 2 and an input keyboard 3. The converter 2 interconnects a mobile phone 4 and the input keyboard 3. The input keyboard 3 is used for transmitting keyboard input, and the converter 2 is used for receiving the keyboard input and further transforming the signal to the mobile phone 4 as input.

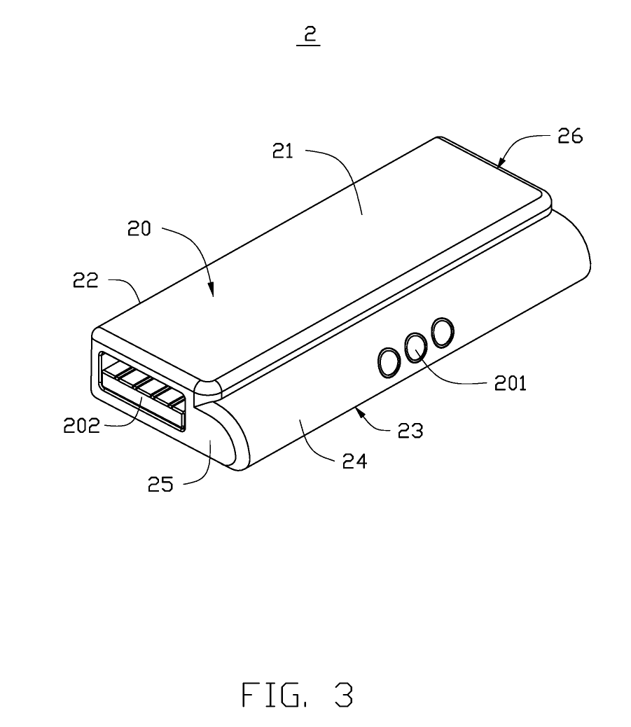

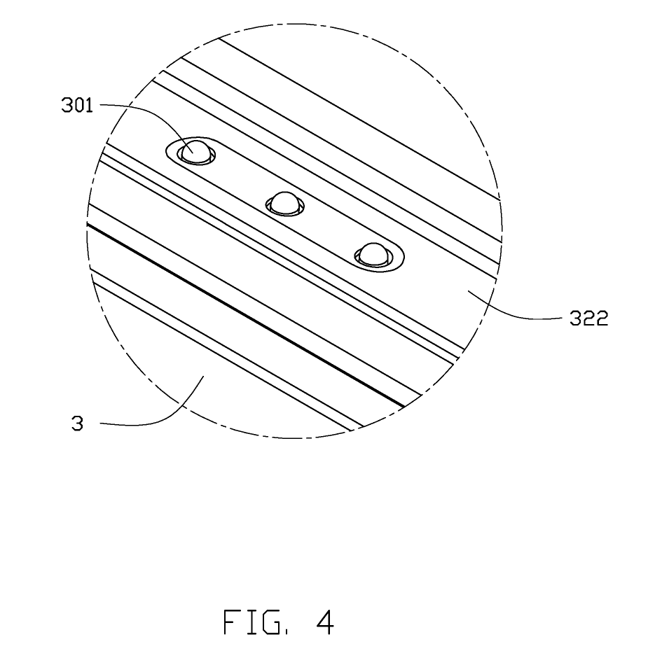

The converter 2 includes a plurality of first contact points 201 as shown in FIG. 3. The input keyboard 3 includes a plurality of second contact points 301 as shown in FIG. 4. Each first contact point 201 abuts with a second contact point 301.

The converter 2 electrically couples with the mobile phone 4. In this exemplary embodiment, a USB interface 202 is defined on the converter 2. A data line 5 is provided to connect the converter 2 and the mobile phone 4. One end of the data line 5 is electrically coupled to the USB interface 202, and the other end of the data line 5 is electrically coupled to a charging interface of the mobile phone 4. Preferably, the data line 5 is a power charging line of the mobile phone 4. In other embodiments, the converter 2 may be provided with BLUETOOTH. The converter 2 and the mobile phone 4 can perform a signal transmission connection through the BLUETOOTH pairing.

The converter 2 includes a main body 20. The main body 20 is substantially cuboid-shaped. The first contact points 201 are mounted in the main body 20. Each first contact point 201 partly extends out of the main body 20 to electrically couple with the second contact point 301. The USB interface 202 is defined on the main body 20.

The main body 20 includes a first surface 21, a second surface 22, a third surface 23, and a fourth surface 24. The first surface 21, the second surface 22, the third surface 23, and the fourth surface 24 are connected in sequence. The first surface 21 and the third surface 23 are opposite to and face away from each other. In this exemplary embodiment, the first surface 21 and the third surface 23 are flat and parallel with each other. The second surface 22 is flat to support the mobile phone 4. In this exemplary embodiment, the second surface 22 is perpendicular to the first surface 21. In other embodiments, the second surface 22 can also be slanted relative to the first surface 21. The second surface 22 is provided to support the mobile phone 4 securely and stably. Preferably, the angle between the second surface 22 and the first surface 21 is an obtuse angle. The first contact points 201 extend out of the main body 20 from the fourth surface 24. In this exemplary embodiment, the fourth surface 24 is a curved surface.

The main body 20 further includes a first end surface 25 and a second end surface 26. The first end surface 25 and the second end surface 26 are opposite to and face away from each other. In this exemplary embodiment, the first end surface 25 and the second end surface 26 are parallel with each other. Both of the first end surface 25 and the second end surface 26 connect the first surface 21, the second surface 22, the third surface 23, and the fourth surface 24. In this exemplary embodiment, the USB interface 202 is defined on the first end surface 25. The USB interface 202 is recessed from the first end surface 25 into the main body 20.

The input keyboard 3 is a wireless device. The wireless keyboard is performed through BLUETOOTH, or other wireless technology. The input keyboard 3 includes a protective casing 31 and a keyboard 32. Both of the protective casing 31 and the keyboard 32 are provided with magnet (not shown in figures) inside, thereby the keyboard 32 can couple to the protective casing 31.

The protective casing 31 is made of soft material, and with support pieces made of a relatively hard material provided inside. The protective casing 31 includes a supporting member 311 and a mounting member 312. The mounting member 312 connects the supporting member 311. The mounting member 312 is provided to couple to the keyboard 32. The supporting member 311 is foldable to support the converter 2 and the mobile phone 4. In this exemplary embodiment, the supporting member 311 can be folded to a triangular shaped column. The column is hollow. The supporting member 311 can also be manipulated to form other shapes in two or three dimension. The converter 2 and the mobile phone 4 can lean against one surface of the supporting member 311 during operation. Specifically, the first surface 21 of the converter 2 abuts against the supporting member 311. The mobile phone 4 is supported by the second surface 22 of the converter 2 and abuts against the supporting member 311.

The keyboard 32 includes a keypad 321 and a connecting member 322. The connecting member 322 is formed on and extends upwards from a top surface of the keypad 321. The connecting member 322 is disposed adjacent to the supporting member 311 of the protective casing 31. The second contact points 301 are mounted in the connecting member 322 as shown in FIG. 4. Each second contact point 301 partly extends out of the connecting member 322 to electrically couple with the first contact point 201.

The keyboard 32 is provided with a wireless transmission circuit (not shown) inside. When the user operates the input keyboard 3, the input signal is transmitted through the wireless transmission circuit, the first contact points 201, and the second contact points 301, to the converter 2, and the converter 2 converts the input signal into commands or other data for the mobile phone 4.

The embodiments shown and described above are only examples. Many details are often found in the art such as the other features of the converter. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A converter for interconnecting an input keyboard and a mobile phone, the converter comprising:
a plurality of first contact points for interconnecting with the input keyboard;
wherein the converter transmits signals and translates to the mobile phone; and
wherein when input keyboard is in operation, the converter converts at least one input signal from the input keyboard into the mobile phone.

2. The converter of claim 1, wherein a data line is provided to connect the converter and the mobile phone; wherein a USB interface is defined on the converter, one end of the data line is electrically coupled to the USB interface, and the other end of the data line is electrically coupled to a charging interface of the mobile phone.

3. The converter of claim 1, wherein the data line is a power charging line of the mobile phone.

4. An external keyboard used in a mobile phone for language input, comprising:
an input keyboard; and
a converter interconnecting the input keyboard and the mobile phone; and
wherein the converter comprises a plurality of first contact points, the input keyboard comprises a plurality of second contact points, and each first contact point abuts a second contact point;
wherein the converter transmits signals and translates to the mobile phone; and
wherein when input keyboard is in operation, the converter converts at least one input signal from the input keyboard into the mobile phone.

5. The external keyboard of claim 4, wherein a data line is provided to connect the converter and the mobile phone; wherein a USB interface is defined on the converter, one end of the data line is electrically coupled to the USB interface, and the other end of the data line is electrically coupled to a charging interface of the mobile phone.

6. The external keyboard of claim 5, wherein the input keyboard comprises a protective casing and a keyboard, and the keyboard is coupled onto the casing.

7. The external keyboard of claim 6,
wherein the keyboard comprises a keypad and a connecting member, the keypad is coupled onto the casing, and the connecting member is formed on and extends from a top surface of the keypad;
wherein the second contact points are mounted in the connecting member, and each second contact point partly extends out of the connecting member to electrically couple with the first contact point.

8. The external keyboard of claim 6, wherein the protective casing comprises a supporting member and a mounting member connected to the supporting member, the keyboard is coupled onto the mounting member; and wherein the supporting member is foldable to support the converter and the mobile phone.

9. The external keyboard of claim 8, wherein the converter comprises a main body, the first contact points are mounted in the main body, and each first contact point partly extends out of the main body to electrically couple with the second contact point.

10. The external keyboard of claim 9,
wherein the main body comprises a first surface, a second surface, a third surface, and a fourth surface; the first surface, the second surface, the third surface, and the fourth surface are connected in sequence;
wherein the first surface and the third surface are opposite to and face away from each other;
wherein the second surface is flat to support the mobile phone, and the first contact points extend out of the main body from the fourth surface.

11. The external keyboard of claim 10, wherein the supporting member can be folded to a triangular shaped column, the column is hollow, the converter and the mobile phone can lean against one surface of the supporting member during operation.

12. The external keyboard of claim 11, wherein the first surface of the main body abuts against the supporting member; and wherein the mobile phone is supported on the second surface of the main body and abuts against the supporting member.

13. The external keyboard of claim 12, wherein the first surface and the third surface are flat and parallel with each other; and the second surface is perpendicular to the first surface.

14. The external keyboard of claim 10, wherein the fourth surface is a curved surface.

15. The external keyboard of claim 10, wherein the main body further comprises a first end surface and a second end surface; and both of the first end surface and the second end surface connect to the first surface, the second surface, the third surface, and the fourth surface; and the USB interface is defined on the first end surface.
